(19) United States
(12) Patent Application Publication
(10) Pub. No.: US 2009/0021181 A1
(43) Pub. Date: Jan. 22, 2009

(54) Led module and led lighting unit with a plurality of led modules

(75) Inventors: Ulf Brune, Bunde (DE); Bernd-Heiner Scholz, Friedrichsdorf (DE)

Correspondence Address: OSRAM SYLVANIA INC, 100 ENDICOTT STREET, DANVERS, MA, 01923, US

(73) Assignee: Patent-Treuhand-Gesellschaft Fur Elektrische GLUHLAMPEN MBH, Munchen (DE)

(21) Appl. No.: 11/918,867

(22) PCT Filed: Apr. 10, 2006
(86) PCT No.: PCT/DE2006/000635

§ 371 Date: Mar. 20, 2008

(30) Foreign Application Priority Data
Apr. 19, 2005 (DE) 102005018175.9

(51) Int. Cl. H05B 37/02

(52) U.S. Cl. 315/291

(57) ABSTRACT

In a LED module (11) with a LED array comprising a plurality of LED chips (2) and a control unit (7) for regulating the operating current of the LED chips (2), the control unit (7) is arranged on a support (4) of the LED module (11) and comprises an electronic storage medium for storing operational data of the LED chips (2), the operating current being regulated according to the stored operational data.

The invention relates to an LED module in accordance with the precharacterizing clause of patent claim 1 and to an LED lighting device with a plurality of such LED modules.

LED arrays are characterized by a high efficiency, a long life, a rapid response time and a comparatively low degree of sensitivity to impacts and vibrations. For this reason, LED arrays are used increasingly frequently in lighting devices in which until now often incandescent lamps have been used, in particular in motor vehicle headlamps.

In LED modules used for lighting purposes, in particular in LED modules for motor vehicle headlamps, the emitted luminous intensity even after a comparatively long operating duration, for example after an operating duration of several thousand hours, should not substantially deviate from the luminous intensity emitted at the time at which it is first used. The luminous intensity emitted by the LED chips of an LED module may possibly be reduced at least slightly with increasing operating duration, however, owing to degradation phenomena.

Such a degradation effect can have a particularly disruptive effect when an individual LED module needs to be replaced, for example owing to a defect, in an LED lighting unit which comprises a plurality of LED modules after a comparatively long operating duration. Firstly, it may arise in this case that the luminous intensity of the replacement module deviates from the luminous intensity of the remaining modules, in particular if, in contrast to the remaining LED modules, it does not yet have any aging-related reduction in the luminous intensity.

Although the technical function of the LED lighting device is generally not substantially impaired by slight differences in the luminous intensity of the individual LED modules, it is often possible for even slight differences to be perceived by a viewer and possibly to be found disruptive. In addition, legal provisions relating to the luminous intensity for example in the case of road traffic need to be adhered to.

In order to avoid different brightnesses of similar LED modules brought about by manufacturing tolerances, LED modules are generally supplied in brightness groups. The brightness of the individual LED modules is therefore measured after manufacture and each LED module is associated with a brightness group corresponding to its brightness. During final fitting of an LED lighting device which comprises a plurality of LED modules, advantageously only LED modules from the same brightness group are used. However, when one of the LED modules is replaced, it is necessary to establish the brightness grouping of the module to be replaced and to replace the LED module with an LED module of the same brightness group.

In order in particular to counteract a reduction in the brightness of an LED module owing to aging phenomena of the LED chips, it is known from the document EP 1 341 402 A2 to measure the brightness of the radiation emitted by an LED module and to feed the measurement signal to the power supply unit of the LED module in order to regulate the current flow through the LED module in such a way that the brightness of the LED module is constant.

In a few applications of LED modules, the implementation of such a regulating circuit is associated with comparatively high technical complexity, however. Often also no separate power supply unit is provided for the operation of the LED module, to which power supply unit feedback of a measurement signal, for example the emitted brightness, could take place in order to regulate the current supply. This is the case, for example, if an LED module contained in a motor vehicle headlamp is supplied with electrical voltage by a motor vehicle battery.

The invention is based on the object of specifying an improved LED module which is characterized in particular by a high degree of long-term stability of the emitted luminous intensity and a precautionary measure by means of which the replacement of the LED module by a similar LED module is simplified.

This object is achieved by an LED module as claimed in patent claim 1. Advantageous configurations and developments of the LED module are the subject matter of the dependent claims.

In an LED module with an LED array comprising a plurality of LED chips and a control unit for regulating an operating current of the LED chips, in accordance with at least one embodiment of the invention the control unit is arranged on a carrier of the LED module and comprises an electronic storage medium for storing operational data of the LED chips, regulation of the operating current as a function of the stored operational data being provided.

Advantageously, the control unit, for example a microcontroller, has a means for detecting the operating duration of the LED chips, the operating duration being stored in the electronic storage medium. The detection of the operating duration of the LED chips of the LED array by means of the control unit makes it possible in particular to match the operational parameters of the LED module to the aging properties of the LED chips.

In a preferred embodiment of the invention, the operating current of the LED chips is regulated by means of the control unit as a function of the operating duration. In particular, provision is made for the operating current of the LED chips to be increased with increasing operating duration. In this way, a reduction in the brightness of the radiation emitted by the LED chips with increasing operating duration owing to degradation phenomena of the LED chips is counteracted.

The increase in the operating current preferably takes place in such a way that a predetermined minimum brightness is not undershot. Particularly preferably, the regulation of the operating current of the LED chips takes place in such a way that the brightness of the emitted radiation is at least approximately constant. This advantageously results in it not being possible to perceive differences in the brightness of otherwise identical LED modules, which differ from one another by the operating duration of the LED chips.

The increase in the operating current of the LED chips preferably takes place at preset times stored in the control unit. For example, the increase in the operating current can take place after previously determined time intervals of the operating duration. The time intervals after which the operating current level is increased do not necessarily need to be of equal length. Furthermore, the current level does not necessarily need to be increased in each case by the same carrier after the predetermined time intervals. Instead, the determination of the time intervals after which in each case an increase in the current level takes place and the determination of the carrier by which the current level is increased in each case advantageously takes place on the basis of empirical values for the degradation behavior of the LED chips.

The operational data stored in the electronic storage medium can be further-processed, for example, by the control unit in order to regulate the operating current as a function of the previous operational data. In particular, the stored operational data can be used by the control unit to determine the time intervals after which the operating current level is intended to be increased for the purpose of compensating for degradation phenomena or the amounts by which the current level is increased in each case. In addition to the operating duration, further operational parameters can also be stored in the store of the control unit and used for such calculations. In particular, in the case of LED modules in which operation of the LED chips of the LED array in a plurality of operating modes with different operating current levels is provided, it is also possible for the operating times in the individual operating modes to be stored. For example, in the case of an LED module which is used in a motor vehicle front headlamp, an operation of the LED chips with different current levels in the operating modes parking light, lower beam or upper beam can be provided.

Furthermore, a brightness grouping of the LED chips is advantageously stored in the electronic storage medium of the control unit. A brightness grouping is in this case understood to mean an indication of the brightness given a reference current level. The current level which is required for achieving a specific brightness can also vary at least slightly given otherwise identical chips. For this reason, LEDs are generally supplied to customers in so-called brightness groupings in order to avoid differences in the brightness when LEDs are arranged next to one another in the case of operation with the same current level.

Storing the brightness grouping in the electronic storage medium of the control unit of the LED module has the advantage that the operating current of the LED chips can be regulated automatically to the value required for a provided brightness using this information. The LED module can therefore advantageously be used in addition to other identical LED modules without any regard for the brightness grouping and without in the process differences occurring in the brightness.

The LED module preferably has an interface for reading the stored operational data and/or for programming the control unit. The interface in a preferred embodiment of the invention is a serial interface. In particular, the interface can be used, in the case of an LED module being replaced in a lighting device which comprises a plurality of identical LED modules, to read the operating duration of the LED module to be replaced and therefore, in the LED module which is intended to replace the LED module to be replaced, to adjust the operating current so as to match the brightness to the remaining LED modules.

The carrier of the LED module is preferably a printed circuit board, for example a metal-core printed board. In a preferred embodiment, the width of the carrier is 12 mm or less. Advantageously, the carrier acts as a heat sink for the heat produced by the LED chips. The carrier preferably contains at least one electrical connection point, by means of which electrical contact can be made in particular with the control apparatus. A plug is provided as the connection point, for example. The electrical connection between the elements of the LED module arranged on the carrier, in particular the control unit with the LED chips, preferably takes place via conductor tracks on the carrier body.

The supply of current to the LED module can take place both with DC voltage and with AC voltage. In a preferred embodiment, the LED module is operated with a supply voltage of between 8 V and 24 V, inclusive. In particular, the supply voltage may be the voltage of a motor vehicle battery, which is approximately 12 V, for example.

Preferably, a means for transforming the supply voltage into the operating voltage provided for operating the LED array is contained on the carrier of the LED module. The operating voltage of the LED array is dependent in particular on the number of LED chips used which are preferably connected in series and is, for example, 18.5 V or less.

The transformation of the supply voltage into the operating voltage takes place, for example, using a step-up converter, which is arranged on the carrier of the LED module. The transformation of the supply voltage to the operating voltage of the LED array by means of an element arranged on the carrier has in particular the advantage that the LED module can be connected directly to the supply voltage, for example a battery voltage in a motor vehicle, without any further precautionary measures.

The LED chips of the LED array are preferably mounted on a chip carrier, which is fixed on the carrier. The carrier and the chip carrier are in this case preferably adhesively bonded to one another. The chip carrier is produced, for example, from a ceramic, preferably AlN. Advantageously, the chip carrier is a heat sink for the heat emitted by the LED chips.

The LED chips preferably contain a III-V compound semiconductor material, in particular InₓAl_{y}Ga_{1-x-y}N, InₓAl_{y}Ga_{1-x-y}P or InₓAl_{y}Ga_{1-x-y}As, where in each case 0≦x≦1, 0≦y≦1 and x+y≦1. In this case, the III-V compound semiconductor material does not necessarily need to have a mathematically exact composition in accordance with one of the above formulae. Instead, it may have one or more dopants and additional constituents which substantially do not change the physical properties of the material. For reasons of simplicity, the above formulae only contain the essential constituents of the crystal lattice however, even if these can be replaced partially by small quantities of other substances.

Particularly preferably, the LED chips are so-called thin film light-emitting diode chips, in which a functional semiconductor layer sequence was initially grown epitaxially on a growth substrate, then a new carrier was applied to the surface of the semiconductor layer sequence which is opposite the growth substrate and subsequently the growth substrate was removed. This has the advantage in particular that the growth substrate can be reused.

A basic principle of a thin layer light-emitting diode chip is described, for example, in I. Schnitzer et al., Appl. Phys. Lett. 63 (16), Oct. 18, 1993, 2174-2176, whose disclosure content in this regard is incorporated herein by reference.

A thin film light-emitting diode chip is, as a good approximation, a Lambert surface radiator and is therefore particularly well suited to application in a headlamp.

A preferred embodiment of the LED module contains a temperature sensor, and regulation of an operating current of the LED chips as a function of a temperature detected by the temperature sensor is provided. For this purpose, the temperature sensor is connected to the control unit, for example by means of conductor tracks on the carrier. Owing to the temperature-dependent regulation of the operating current of the LED chips of the LED array, it is possible to avoid the function being impaired or even failure of the LED chips owing to thermal overload. In particular, the temperature detected by the temperature sensor can be evaluated by the control unit, and the operating current of the LED chips can be reduced as soon as the temperature detected by the temperature sensor reaches a critical value. In this way, the LED chips can advantageously be operated over long operating times within the limit range of its thermal loading capacity.

The temperature monitoring by means of the temperature sensor is in particular advantageous when the LED array contains a large number of LED chips since the heat development also increases with the number of LED chips.

In a preferred embodiment of the invention, the LED array contains at least four LED chips. For example, the LED array may have six LED chips.

The temperature sensor is, for example, an NTC or PTC thermistor, a semiconductor component or a thermocouple. If the LED chips of the LED array are mounted on a chip carrier, the temperature sensor is preferably fixed on the chip carrier. Alternatively, the temperature sensor can also be arranged on the carrier. The fixing of the temperature sensor to the chip carrier or to the carrier preferably takes place by means of soldering or adhesive bonding.

In order to achieve as effective correspondence as possible between the temperature detected by the temperature sensor and the temperature of the radiation-emitting active layers of the LED chips, it is advantageous if the temperature sensor has as small a distance as possible from at least one of the LED chips. Preferably, the distance between the temperature sensor and at least one LED chip of the LED array is 5 mm or less, particularly preferably 3 mm or less.

In a further preferred embodiment, the LED module contains a light detector, for example a photodiode. Advantageously, regulation of the operating current of the LED chips by the control unit as a function of a luminous intensity measured by the light detector is provided. For this purpose, the light detector is preferably connected to the control unit, for example via conductor tracks on the carrier.

In a preferred embodiment, the light detector is arranged in such a way that it receives at least some of the radiation, for example stray radiation, emitted by the LED chips. In this case, the signal of the light detector can be evaluated by the control unit in such a way that the brightness emitted by the LED chips is regulated to a predetermined value by means of a desired/actual value comparison.

In a further embodiment, the light detector is suitable for detecting the ambient brightness. For this purpose, the light detector is preferably arranged and/or aligned in such a way that it primarily detects light from outside the LED module. In this case, advantageously at least only a small carrier of the radiation emitted by the LED chips of the LED module is incident on the light detector. A signal, which is dependent on the ambient luminous intensity and is supplied by the light detector to the control unit, can be used by the control unit in particular for the purpose of regulating the operating current of the LED chips in such a way that the luminous intensity emitted by the LED module is matched to the ambient light conditions.

Advantageously, the signal of the light detector can be evaluated by the control unit also for the purpose of bringing about an automatic switch-on or switch-off operation. For example, in this way an automatic switch-on operation can be brought about in the case of an LED module used in a motor vehicle headlamp given a reduced ambient brightness, for example when entering a tunnel or on the onset of dusk.

Preferably at least one beam-shaping optical element is arranged downstream of the LED chips of the LED array in their emission direction. Advantageously, the divergence of the radiation emitted by the LED chips is reduced by the beam-shaping optical element.

The beam-shaping optical element is preferably a hollow body having a light entry opening facing the LED chips and a light exit opening opposite the light entry opening, at least some of the radiation emitted by the LED chip(s) being reflected on a wall of the hollow body towards the light exit opening.

An advantageous embodiment of the beam-shaping optical element consists in the fact that the cross section of the hollow body is enlarged from the light entry opening towards the opposite light exit opening. Furthermore, the hollow body may have an axis of symmetry which is parallel to a main emission direction of the LED chips.

The beam-shaping optical element may be, for example, a hollow body filled with a casting material. The casting material is preferably a UV-stable material, such as silicone, for example.

A wall of the hollow body preferably has a curvature in order to realize a desired optical functionality. In particular, the wall of the hollow body can be aspherically, for example parabolically, elliptically or hyperbolically, curved.

In a further preferred embodiment, the beam-shaping optical element is in the form of a CPC-, CEC- or CHC-like optical concentrator, in this case and in the text which follows a concentrator being intended whose reflecting side faces have at least partially and/or at least largely the shape of a compound parabolic concentrator (CPC), a compound elliptic concentrator (CEC) or a compound hyperbolic concentrator (CHC). In this case, that surface of the covering body which faces the LED chips is the actual concentrator output, with the result that, in comparison with the conventional use of a concentrator for focusing purposes, radiation passes through it in the reverse direction and is therefore not concentrated, but leaves the covering body with reduced divergence through the opposite surface.

An LED lighting device in accordance with the invention comprises a plurality of the above-described LED modules. An LED module in accordance with the invention may in particular be part of a motor vehicle headlamp, the motor vehicle headlamp advantageously containing a plurality of such LED modules.

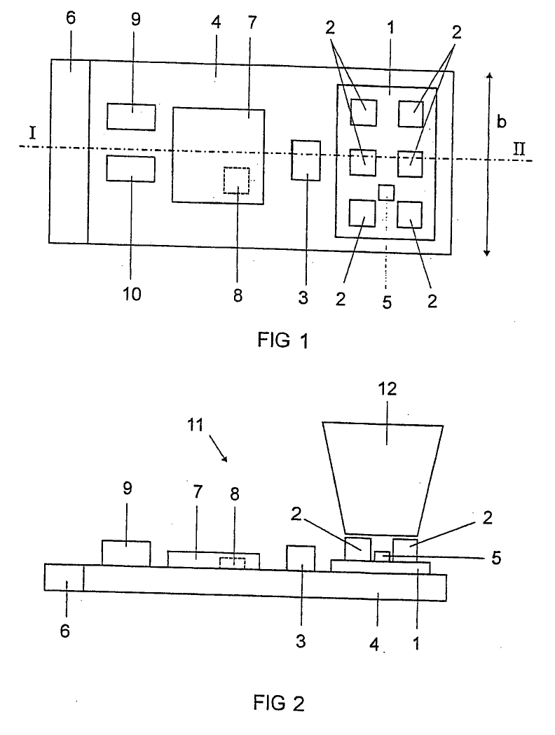

The invention will be explained in more detail below with reference to an exemplary embodiment in connection with FIGS. 1 and 2, in which:

FIG. 1 shows a schematically illustrated plan view of an exemplary embodiment of an LED module in accordance with the invention, and

FIG. 2 shows a schematic illustration of a cross section along the line I-II of the exemplary embodiment of the invention illustrated in FIG. 1.

Identical or functionally identical elements have been provided with the same reference symbols in the figures.

The exemplary embodiment of an LED module 11 in accordance with the invention and illustrated schematically in FIGS. 1 and 2 contains an LED array, in which six LED chips 2 are mounted on a common chip carrier 1.

The LED chips 2 have an active zone, which preferably contains a III-V compound semiconductor material, in particular InₓAl_{y}Ga_{1-x-y}N, InₓAl_{y}Ga_{1-x-y}P or InₓAl_{y}Ga_{1-x-y}As, where 0≦x≦1, 0≦y≦1 and x+y≦1. The active zone may be in the form of a single heterostructure, double heterostructure, single quantum well structure or multiple quantum well structure. The term quantum well structure in the context of the application encompasses any structure in which charge carriers experience quantization of their energy states as a result of confinement. In particular, the term quantum well structure does not include any indication as to the dimensionality of the quantization. It therefore encompasses, inter alia, quantum wells, quantum wires and quantum dots and any combination of these structures.

The chip carrier 1 preferably consists of a ceramic. In particular, the chip carrier 1 may contain AlN. The LED chips 2 of the LED array are preferably connected in series. Alternatively, the LED chips 2 can also be connected in parallel.

The LED module 11 has a carrier 4, onto which in particular the chip carrier 1 with the LED chips 2 is mounted. The carrier 4 preferably has a width b of 12 mm or less. In particular, the carrier 4 may be a metal-core printed board, which advantageously acts as a heat sink for the heat produced by the LED chips 2, the heat produced by the LED chips 2 being emitted to the metal-core printed board 4 via the chip carrier 1. Bores can be provided in the carrier 4 in order to carrier the LED module in a lighting device, for example by means of screws or locating pins.

Furthermore, a control unit 7 is arranged on the carrier 4 of the LED module 11. The control unit 7 is, for example, an electronic chip, which is preferably mounted on the carrier 4 using flip-chip technology. The control unit 7 advantageously has an electronic storage medium 8 for storing operational data of the LED chips 2. The operating current of the LED chips 2 is regulated by the control unit 7 as a function of the stored operational data.

Provision is made in particular for the control unit 7 to have a means for detecting the operating duration of the LED chips 2, the operating duration being stored in the electronic storage medium 8 and the operating current of the LED chips 2 being regulated as a function of the operating duration.

The regulation of the operating current of the LED chips 2 as a function of the operating duration in this case preferably takes place in such a way that the operating current is increased with increasing operating duration, in order to counteract a reduction in the brightness owing to degradation phenomena of the LED chips 2. In this way, it is possible in particular for the brightness of the radiation emitted by the LED chips 2, even after a long operating duration of, for example, several thousand hours, to at least not substantially deviate from an initial value at the time of first use.

The brightness of the radiation emitted by the LED module 11 is therefore advantageously constant over time. For example, provision may be made for a luminous flux of 400 lm to be maintained.

The times at which the operating current level of the LED chips 2 is increased in each case so as to compensate for aging phenomena of the LED chips are preferably stored in the electronic storage medium 8 of the control unit 7. An increase in the operating current level therefore takes place automatically in each case when the operating duration of the LED chips 2, which is detected by the control unit 7 and summated, corresponds to the preset times. The carrier of the increase and the time intervals after which in each case an increase takes place is advantageously determined from empirical values for the aging response of the LED chips 2, for example from a measured profile of the luminous intensity as a function of time.

Instead of such a stepwise increase in the operating current level, it is alternatively also possible for a continuous increase in the operating current level as a function of the operating duration of the LED chips 2 to be provided.

Furthermore, a brightness grouping of the LED chips 2 is advantageously stored in the electronic storage medium 8 of the control unit 7. This has the advantage in particular that the operating current of the LED chips 2 can be regulated automatically by the control unit 7 to the value required for a provided brightness using this information. As a result, there are advantageously no perceivable differences in the brightness if the LED module 11 is arranged next to other identical LED modules.

In order to read the stored operational data, the control unit 7 advantageously has an interface (not illustrated). In particular, the interface may be a serial interface. Programming of the control unit 7 can also take place via the serial interface.

As an external connection, for example for the serial interface or the current supply to the control unit 7, a plug 6 is provided.

Depending on the intended use of the LED module 11, either an AC voltage, for example a system voltage, or a DC voltage, for example a battery voltage, in particular a battery voltage of a motor vehicle battery, can be provided for current supply purposes. In order to transform the supply voltage, for example using a step-up converter, electronic components required for this purpose, for example an inductor coil 9 and a capacitor 10, can be arranged on the carrier 4.

Furthermore, a temperature sensor 3, which is connected to the control unit 7, is advantageously arranged on the carrier 4 of the LED module 11. The connection of the electronic components contained on the carrier 4 takes place, for example, via conductor tracks (not illustrated) on the carrier 4. The temperature sensor 3, for example a temperature-dependent resistor, a thermocouple or a semiconductor component having temperature-dependent properties, is in thermal contact with the LED chips 2, for example by means of thermal conduction or convection. In particular, the temperature sensor is used for bringing about a reduction in the operating current of the LED chips 2 by means of the control unit 7 when a critical temperature is exceeded.

Furthermore, the LED module 11 preferably contains a light detector 5, which is arranged, for example, on the chip carrier 1 and is connected to the control unit 7. The light detector 5 is arranged, for example, on the chip carrier 1 in order to receive at least some of the radiation emitted by the LED chips 2. In particular, provision may be made for the signal of the light detector 5 to be evaluated by the control unit 7 in such a way that the brightness emitted by the LED chips 2 is regulated to a predetermined value by means of a desired/actual value comparison.

Alternatively, the light detector 5 could also be mounted at another point on the carrier 4 in order to receive, for example, the ambient brightness or at least some of the radiation emitted by adjacent LED modules which may be provided. In this case, the signal produced by the light detector 5 can be evaluated by the control unit 7 in such a way that the operating current of the LED chips 2 is regulated in such a way that the luminous intensity emitted by the LED module 11 is matched to the ambient light conditions.

For beam shaping of the radiation emitted by the LED chips 2, advantageously at least one optical element 12 is provided. In particular, an optical element 12 can be provided which reduces the divergence of the radiation emitted by the LED chips 2. For example, the optical element 12 may be a non-imaging optical concentrator, which is preferably arranged very close to the LED chips 2 or even positioned on them.

The non-imaging optical concentrator is preferably a CPC-, CEC- or CHC-like optical concentrator, whose reflecting side walls have at least partially and/or at least largely the shape of a compound parabolic concentrator (CPC), a compound elliptic concentrator (CEC) and/or a compound hyperbolic concentrator (CHC).

The invention is not restricted by the description with reference to the exemplary embodiments. Instead, the invention encompasses any novel feature and any combination of features, which in particular includes any combination of features in the patent claims, even if this feature or this combination itself is not explicitly cited in the patent claims or exemplary embodiments. For example, it is also possible for a plurality of LED arrays and a plurality of control apparatuses 7 to be arranged on the carrier 4.

1. An LED module (11) with at least one LED array comprising a plurality of LED chips (2) and at least one control unit (7) for regulating an operating current of the LED chips (2), characterized in that the at least one control unit (7) is arranged on a carrier (4) of the LED module (11) and has an electronic storage medium (8) for storing operational data of the LED chips (2), and regulation of the operating current as a function of the stored operational data is provided.

2. The LED module as claimed in claim 1, characterized in that the at least one control unit (7) has a means for detecting the operating duration of the LED chips (2), the operating duration being stored in the electronic storage medium (8), and the operating current of the LED chips (2) being regulated as a function of the operating duration.

3. The LED module as claimed in claim 2, characterized in that an increase in the operating current of the LED chips (2) with increasing operating duration is provided.

4. The LED module as claimed in claim 1, characterized in that a brightness grouping of the LED chips (2) is stored in the electronic storage medium (8).

5. The LED module as claimed in claim 1, characterized in that the LED module (11) has an interface for reading the stored operational data and/or for programming the at least one control unit (7).

6. The LED module as claimed in claim 1, characterized in that a means for transforming a supply voltage into an operating voltage provided for operating the LED array is arranged on the carrier (4) of the LED module (11).

7. The LED module as claimed in claim 1, characterized in that the LED module (11) contains a temperature sensor (3).

8. The LED module as claimed in claim 7, characterized in that regulation of the operating current of the LED chips (2) as a function of a temperature measured by the temperature sensor (3) is provided.

9. The LED module as claimed in claim 7, characterized in that the distance between at least one of the LED chips (2) and the temperature sensor (3) is 5 mm or less.

10. The LED module as claimed in claim 1, characterized in that the LED module contains a light detector (5).

11. The LED module as claimed in claim 10, characterized in that the light detector (5) is an ambient light detector.

12. The LED module as claimed in claim 10, characterized in that regulation of the operating current of the LED chips (2) as a function of a luminous intensity measured by the light detector (5) is provided.

13. The LED module as claimed in claim 1, characterized in that the at least one LED array comprises a chip carrier (1) on which the LED chips (2) are arranged, the chip carrier (1) being arranged on the carrier (4).

14. The LED module as claimed in claim 1, characterized in that the carrier (4) has a width of 12 mm or less.

15. The LED module as claimed in claim 1, characterized in that the at least one LED array contains at least four LED chips (2).

16. The LED module as claimed in claim 1, characterized in that the at least one LED array has at least one optical element (12) for beam shaping of the radiation emitted by the LED chips (2).

17. The LED module as claimed in claim 16, characterized in that the optical element (12) is a non-imaging optical concentrator.

18. The LED module as claimed in claim 1, characterized in that it is part of a motor vehicle headlamp.

19. An LED lighting device, characterized in that it comprises a plurality of LED modules (11) as claimed in claim 1.

20. The LED module as claimed in claim 8, characterized in that the distance between at least one of the LED chips (2) and the temperature sensor (3) is 5 mm or less.
